(19) United States
(12) Patent Application Publication
(10) Pub. No.: US 2023/0299979 A1
(43) Pub. Date: Sep. 21, 2023

(54) DEVICE CERTIFICATE MANAGEMENT FOR ZERO TOUCH DEPLOYMENT IN AN ENTERPRISE NETWORK

(71) Applicant: Cisco Technology, Inc., San Jose, CA (US)

(72) Inventors: Manoj Kumar Kushwaha, Bangalore (IN); Scott Taft Potter, Stratford, CT (US); David Scott McCowan, Cary, NC (US); Shailendra Bhargava, San Ramon, CA (US); Michael Freed, Pleasanton, CA (US)

(21) Appl. No.: 17/824,117

(22) Filed: May 25, 2022

(30) Foreign Application Priority Data
Feb. 26, 2022 (IN) 202241010386

(51) Int. Cl. H04L 9/32; H04L 9/08

(52) U.S. Cl. CPC H04L 9/3268; H04L 9/0866; H04L 9/3247

(57) ABSTRACT

Disclosed are techniques for dynamically creating policy-based intermediate certificates to sign device certificates of devices deployed in an enterprise network using ZTD. In one aspect, a method includes receiving network policy information to be used for creating policy-based intermediate certificates, each one of the policy-based intermediate certificates being used by a network controller for signing devices certificates of a different cluster of connected IoT devices; receiving, from an IoT device, a request for registration with the network controller; based on identifying information of the IoT device included in the request, determining one of the policy-based intermediate certificates to sign a device certificate of the loT device; and transmitting, to the IoT device, the device certificate signed using the one of the policy-based intermediate certificates.

### CROSS-REFERENCE TO RELATED APPLICATIONS

This application claims the benefit of priority to Indian Provisional Patent Application No. No. 202241010386 filed on Feb. 26, 2022 and titled “POLICY-BASED INTERMEDIATE CERTIFICATE AUTHORITY FOR ZERO TOUCH DEPLOYMENT,” the disclosure of which is herein incorporated by reference in its entirety.

### TECHNICAL FIELD

The present disclosure generally relates to the field of computer networking, and more particularly to creation and management of intermediate certificates used for signing device certificates for Zero Touch Deployment (ZTD) service in an enterprise network.

### BACKGROUND

As Internet-of-Things (IoT) devices continue to grow in popularity, so too may the complexity of many IoT deployments and their management. For example, enterprise IoT deployments may include thousands of different IoT devices, many of which consume wireless data and/or interact with multiple different networked entities.

The amount of time needed for provisioning IoT devices can significantly delay the deployment. Also, manual provisioning is prone to human errors. Managing operations of onboarded IoT devices and underlying security concerns pose additional challenges. By incorporating zero-touch deployment (ZTD), multiple IoT devices can be onboarded, configured automatically, and their operations managed with less effort and with little to no-human intervention.

### BRIEF DESCRIPTION OF THE FIGURES

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 illustrates an example of a physical topology of an enterprise network according to some aspects of the present disclosure;

FIG. 2 illustrates an example of a logical architecture for an enterprise network according to some aspects of the present disclosure;

FIG. 3 illustrates a simplified network architecture of an enterprise network that utilizes a ZTD service, according to some aspects of the present disclosure;

FIG. 4 illustrates an enhanced version of network architecture of FIG. 3, according to some aspects of the present disclosure;

FIG. 5 illustrates a process flow for device certificate management in a ZTD environment, according to some aspects of the present disclosure;

FIG. 6 illustrates an example method for device certificate management in a ZTD environment, according to some aspects of the present disclosure;

FIG. 7 illustrates an example of a network device, according to some aspects of the present disclosure; and

FIG. 8 illustrates an example computing system, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed are systems, apparatuses, methods, and computer-readable media for dynamically creating policy-based intermediate certificates to sign device certificates of devices (e.g., IoT devices) deployed in an enterprise network using ZTD. Techniques described herein would eliminate the need for direct signing of device certificates with a ZTD linked customer certificate authority, which can lead to massive and across the board revocation of device certificates in case of security breach or compromised device certificates.

In one aspect, a method includes receiving network policy information to be used for creating policy-based intermediate certificates, each one of the policy-based intermediate certificates being used by a network controller for signing devices certificates of a different cluster of connected IoT devices; receiving, from an IoT device, a request for registration with the network controller; based on identifying information of the IoT device included in the request, determining one of the policy-based intermediate certificates to sign a device certificate of the IoT device; and transmitting, to the IoT device, the device certificate signed using the one of the policy-based intermediate certificates.

In another aspect, the method further includes generating, by the network controller, the policy-based intermediate certificates based on the policy information, the policy information including parameters for organizing the connected IoT devices into a plurality of clusters.

In another aspect, the parameters include one or more of a device type, device configurations, a geographical location of an IoT device, and a threshold number of IoT devices to be associated with each of the plurality of clusters.

In another aspect, determining one of the policy-based intermediate certificates for signing the device certificate of the IoT device includes associating the IoT device with one of the plurality of clusters based on the identifying information of the IoT device, the one of the plurality of clusters being associated with one of the policy-based intermediate certificates.

In another aspect, each policy-based intermediate certificate is linked to a root certificate issued by a certificate authority.

In another aspect, the method further includes determining that one or more of the policy-based intermediate certificates are to be revoked; identifying a group of IoT devices associated with each of the one or more of the policy-based intermediate certificates that are to be revoked; revoking signed device certificates for the group of IoT devices; and signing the device certificates for the group of IoT devices using a new policy-based intermediate certificate.

In another aspect, the method further includes dynamically generating the policy-based intermediate certificates when registration requests from one or more IoT devices are received at the network controller.

In one aspect, a network controller includes one or more memories having computer-readable instructions stored therein; and one or more processors. The one or more processors are configured to execute the computer-readable instructions to receive network policy information to be used for creating policy-based intermediate certificates, each one of the policy-based intermediate certificates being used by the network controller for signing devices certificates of a different cluster of connected IoT devices; receive, from an IoT device, a request for registration with the network controller; based on identifying information of the IoT device included in the request, determine one of the policy-based intermediate certificates to sign a device certificate of the IoT device; and transmit, to the IoT device, the device certificate signed using the one of the policy-based intermediate certificates.

In another aspect, the network controller is a Zero Touch Deployment (ZTD) controller of a ZTD service used in an enterprise network to on-board and manage connected IoT devices.

In one aspect, one or more non-transitory computer-readable media include computer-readable instructions, which when executed by one or more processors of a network controller, cause the network controller to receive network policy information to be used for creating policy-based intermediate certificates, each one of the policy-based intermediate certificates being used by the network controller for signing devices certificates of a different cluster of connected IoT devices; receive, from an IoT device, a request for registration with the network controller; based on identifying information of the IoT device included in the request, determine one of the policy-based intermediate certificates to sign a device certificate of the IoT device; and transmit, to the IoT device, the device certificate signed using the one of the policy-based intermediate certificates.

### Description of Example Embodiments

In ZTD practice based on a public key infrastructure (PKI), devices (e.g., IoT devices) are assigned client certificates from a certificate authority (CA) (e.g., x509 client certificates). The CA can be an external or internal CA linked with ZTD services that are utilized by an enterprise network. Also, the CA can be a root or intermediate CA that issues root or intermediate certificates. Further, the CA can issue client certificates by using which devices get authenticated on private or public service provisioning services (e.g., IoT Hub Device Provisioning Service (DPS)).

In particular, the ZTD service assigns client certificates to all enterprise devices directly signed by a linked CA. However, if the linked CA becomes invalid, revocation of the old client certificates and reissue of new client certificates can be problematic due to a large number of devices with certificates signed by the CA. One approach to solve this problem is to mark the compromised certificates as blocked in DPS. However, marking individual certificates as blocked can lead to an uncontrolled huge revocation list, which can be a slow process. Alternatively, another approach is to change the root certificate uploaded on DPS. However, invalidating root certificates on DPS can lead to all enterprise devices becoming invalid and requires that new certificates be issued to all of the enterprise devices. Therefore, existing approaches of directly signing device certificates with ZTD-linked customer CA can become burdensome and strenuous with a vast number of devices in a network. Therefore, there exists a need for finer control on the device certificates.

The present disclosure includes systems, methods, and computer-readable media for solving these problems and discrepancies. More specifically, the present disclosure provides improved control and management of client certificates that are signed by a linked CA by dynamically creating an on-demand intermediate CA, and therefore connecting a smaller subset of enterprise devices to a CA. The present disclosure can further include grouping devices among smaller clusters based on policy and issuing certificates from the policy-linked intermediate CA where an intermediate certificate can be dynamically determined at the enrollment time of the device.

In the present disclosure, it is understood that the terms “intermediate certificate authority (CA)” and “sub-CA” are used interchangeably without limiting the scope and meaning of any term. Also, the terms “intermediate certificate” and “sub-certificate” are used interchangeably herein.

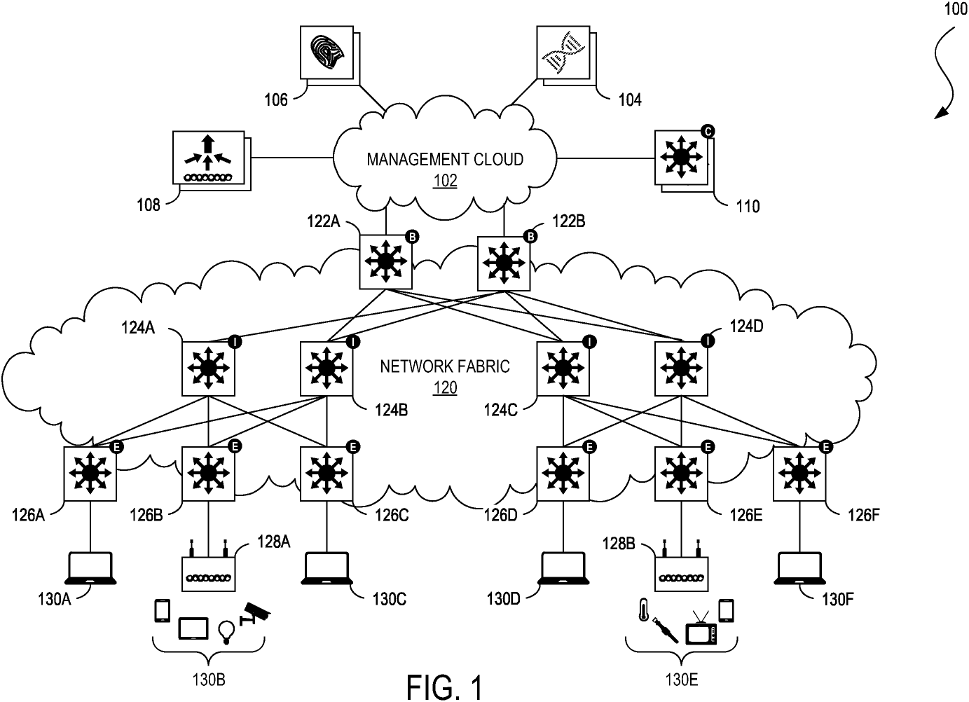

FIG. 1 illustrates an example of a physical topology of an enterprise network according to some aspects of the present disclosure. Network 100 can be an enterprise network, for providing intent-based networking. It should be understood that, for the network 100 and any network discussed herein, there can be additional or fewer nodes, devices, links, networks, or components in similar or alternative configurations. Example embodiments with different numbers and/or types of endpoints, nodes, cloud components, servers, software components, devices, virtual or physical resources, configurations, topologies, services, appliances, or deployments are also contemplated herein. Further, the network 100 can include any number or type of resources, which can be accessed and utilized by endpoints or network devices. The illustrations and examples provided herein are for clarity and simplicity.

Intent-based networking is an approach for overcoming the deficiencies, discussed above and elsewhere in the present disclosure, of conventional enterprise networks. The motivation of intent-based networking is to enable a user to describe in plain language what he or she wants to accomplish (e.g., the user’s intent) and have the network translate the user’s objective into configuration and policy changes that are automatically propagated across a complex and heterogeneous computing environment. Thus, an intent-based network can abstract network complexity, automate much of the work of provisioning and managing the network typically handled by a network administrator, and assure secure operation and optimal performance of the network. As an intent-based network becomes aware of the users, devices, and things making connections in the network, it can automatically apply security permissions and service levels in accordance with the privileges and quality of experience (QoE) assigned to the users, devices, and things. Table 1 sets forth examples of intents and workflows that can be automated by an intent-based network to achieve a desired outcome.

TABLE 1

Examples of Intents and Associated Workflows

| | |
|---|---|
| Intent | Workflow |
| I need to scale out my application database | Extend network segments; update load balancer configuration; configure quality of service (QoS) |
| I have scheduled a telemedicine session at 10am | Create high-definition (HD) video connection; prioritize with end-to-end QoS; validate performance; keep the communication safe; tear down connection after call |
| I am rolling out a new IoT app for factory equipment monitoring | Create a new segment for all factory devices to connect to the IoT app; isolate from other traffic; apply service level agreement (SLA); validate SLA; optimize traffic flow |
| I need to deploy a secure multi-tier application | Provision multiple networks and subnets; configure access control lists (ACLs) and firewall rules; advertise routing information |

Some additional examples of use cases of an intent-based network:

An intent-based network can learn the performance needs of applications and services and adapt the network from end-to-end to achieve specified service levels;

Instead of sending technicians to every office, floor, building, or branch, an intent-based network can discover and identify devices and things as they connect, assign security and micro-segmentation profiles according to established policies, and continuously monitor access point performance to automatically adjust for QoE;

Users can move freely among network segments, mobile device in hand, and automatically connect with the correct security and access privileges;

Switches, routers, and other network devices can be powered up by local non-technical office personnel, and the network devices can be configured remotely (by a user or by the network) via a cloud management console with the appropriate policies as defined by the intents for the specific location (e.g., permanent employee access, visiting employee access, guest access, etc.); and

Machine learning and artificial intelligence agents running in the network can continuously monitor and analyze network traffic and connections, compare activity against pre-defined intents such as application performance or security policies, detect malware intrusions in encrypted traffic and automatically isolate infected devices, and provide a historical record of network events for analysis and troubleshooting.

The network 100 includes a network management system 102 and a network fabric 120. Although shown as an external network or cloud to the network fabric 120 in this example, the network management system 102 may alternatively or additionally reside on the premises of an organization or in a colocation center (in addition to being hosted by a cloud provider or similar environment). The network management system 102 can provide a central management plane for building and operating the network fabric 120. The network management system 102 can be responsible for forwarding configuration and policy distribution, as well as device management and analytics. The network management system 102 can comprise one or more network controller appliances 104, one or more authentication, authorization, and accounting (AAA) appliances 106, one or more wireless local area network controllers (WLCs) 108, and one or more fabric control plane node(s) 110. In other embodiments, one or more elements of the network management system 102 may be co-located with the network fabric 120.

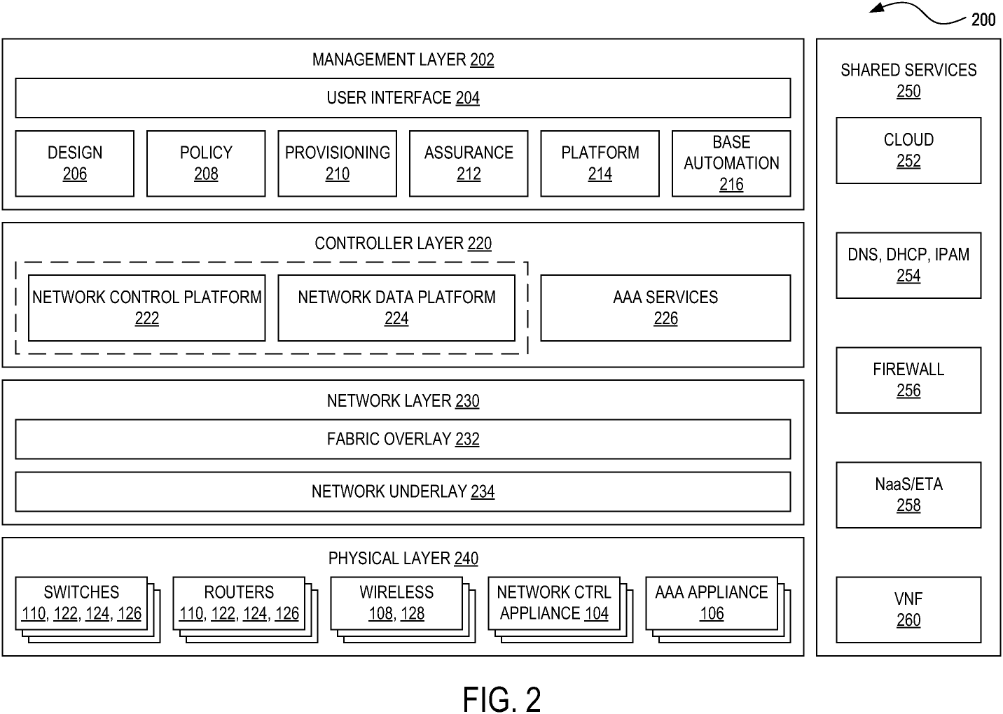

The network controller appliance(s) 104 can function as the command and control system for one or more network fabrics, and can house automated workflows for deploying and managing the network fabric(s). The network controller appliance(s) 104 can include automation, design, policy, provisioning, and assurance capabilities, among others, as discussed further below with respect to FIG. 2. In some embodiments, one or more Digital Network Architecture (Cisco DNA® developed by Cisco Technologies, Inc. of San Jose, CA) appliances can operate as the network controller appliance(s) 104.

The AAA appliance(s) 106 can control access to computing resources, facilitate enforcement of network policies, audit usage, and provide information necessary to bill for services. The AAA appliance can interact with the network controller appliance(s) 104 and with databases and directories containing information for users, devices, things, policies, billing, and similar information to provide authentication, authorization, and accounting services. In some embodiments, the AAA appliance(s) 106 can utilize Remote Authentication Dial-In User Service (RADIUS) or Diameter to communicate with devices and applications. In some embodiments, one or more Cisco® Identity Services Engine (ISE) appliances can operate as the AAA appliance(s) 106.

The WLC(s) 108 can support fabric-enabled access points attached to the network fabric 120, handling traditional tasks associated with a WLC as well as interactions with the fabric control plane for wireless endpoint registration and roaming. In some embodiments, the network fabric 120 can implement a wireless deployment that moves data-plane termination (e.g., VXLAN) from a centralized location (e.g., with previous overlay Control and Provisioning of Wireless Access Points (CAPWAP) deployments) to an access point/fabric edge node. This can enable distributed forwarding and distributed policy application for wireless traffic while retaining the benefits of centralized provisioning and administration. In some embodiments, one or more Cisco® Wireless Controllers, Cisco® Wireless LAN, and/or other Cisco DNA®-ready wireless controllers developed by Cisco Technologies, Inc. of San Jose, CA, can operate as the WLC(s) 108.

The network fabric 120 can comprise fabric border nodes 122A and 122B (collectively, 122), fabric intermediate nodes 124A-D (collectively, 124), and fabric edge nodes 126A-F (collectively, 126). Although the fabric control plane node(s) 110 are shown to be external to the network fabric 120 in this example, in other embodiments, the fabric control plane node(s) 110 may be co-located with the network fabric 120. In embodiments where the fabric control plane node(s) 110 are co-located with the network fabric 120, the fabric control plane node(s) 110 may comprise a dedicated node or set of nodes or the functionality of the fabric control node(s) 110 may be implemented by the fabric border nodes 122.

The fabric control plane node(s) 110 can serve as a central database for tracking all users, devices, and things as they attach to the network fabric 120, and as they roam around. The fabric control plane node(s) 110 can allow network infrastructure (e.g., switches, routers, WLCs, etc.) to query the database to determine the locations of users, devices, and things attached to the fabric instead of using a flood and learn mechanism. In this manner, the fabric control plane node(s) 110 can operate as a single source of truth about where every endpoint attached to the network fabric 120 is located at any point in time. In addition to tracking specific endpoints (e.g., /32 address for IPv4, /128 address for IPv6, etc.), the fabric control plane node(s) 110 can also track larger summarized routers (e.g., IP/mask). This flexibility can help in summarization across fabric sites and improve overall scalability.

The fabric border nodes 122 can connect the network fabric 120 to traditional Layer 3 networks (e.g., non-fabric networks) or to different fabric sites. The fabric border nodes 122 can also translate context (e.g., user, device, or thing mapping and identity) from one fabric site to another fabric site or to a traditional network. When the encapsulation is the same across different fabric sites, the translation of fabric context is generally mapped 1:1. The fabric border nodes 122 can also exchange reachability and policy information with fabric control plane nodes of different fabric sites. The fabric border nodes 122 also provide border functions for internal networks and external networks. Internal borders can advertise a defined set of known subnets, such as those leading to a group of branch sites or to a data center. External borders, on the other hand, can advertise unknown destinations (e.g., to the Internet similar in operation to the function of a default route).

The fabric intermediate nodes 124 can operate as pure Layer 3 forwarders that connect the fabric border nodes 122 to the fabric edge nodes 126 and provide the Layer 3 underlay for fabric overlay traffic.

The fabric edge nodes 126 can connect endpoints to the network fabric 120 and can encapsulate/decapsulate and forward traffic from these endpoints to and from the network fabric. The fabric edge nodes 126 may operate at the perimeter of the network fabric 120 and can be the first points for attachment of users, devices, and things and the implementation of policy. In some embodiments, the network fabric 120 can also include fabric extended nodes (not shown) for attaching downstream non-fabric Layer 2 network devices to the network fabric 120 and thereby extend the network fabric. For example, extended nodes can be small switches (e.g., compact switch, industrial Ethernet switch, building automation switch, etc.) which connect to the fabric edge nodes via Layer 2. Devices or things connected to the fabric extended nodes can use the fabric edge nodes 126 for communication to outside subnets.

In some embodiments, all subnets hosted in a fabric site can be provisioned across every fabric edge node 126 in that fabric site. For example, if the subnet 10.10.10.0/24 is provisioned in a given fabric site, this subnet may be defined across all of the fabric edge nodes 126 in that fabric site, and endpoints located in that subnet can be placed on any fabric edge node 126 in that fabric. This can simplify IP address management and allow deployment of fewer but larger subnets. In some embodiments, one or more Cisco® Catalyst switches, Cisco Nexus® switches, Cisco Meraki® MS switches, Cisco® Integrated Services Routers (ISRs), Cisco® Aggregation Services Routers (ASRs), Cisco® Enterprise Network Compute Systems (ENCS), Cisco® Cloud Service Virtual Routers (CSRvs), Cisco Integrated Services Virtual Routers (ISRvs), Cisco Meraki® MX appliances, and/or other Cisco DNA-ready® devices can operate as the fabric nodes 122, 124, and 126.

The network 100 can also include wired endpoints 130A, 130C, 130D, and 130F and wireless endpoints 130B and 130E (collectively, 130). The wired endpoints 130A, 130C, 130D, and 130F can connect by wire to fabric edge nodes 126A, 126C, 126D, and 126F, respectively, and the wireless endpoints 130B and 130E can connect wirelessly to wireless access points 128B and 128E (collectively, 128), respectively, which in turn can connect by wire to fabric edge nodes 126B and 126E, respectively. In some embodiments, Cisco Aironet® access points, Cisco Meraki® MR access points, and/or other Cisco DNA®-ready access points can operate as the wireless access points 128.

The endpoints 130 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 130 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc); retail equipment (e.g., vending machines, point of sale (POS) devices, Radio Frequency Identification (RFID) tags, etc.); smart city devices (eg., street lamps, parking meters, waste management sensors, etc.); transportation and logistical equipment (e.g., turnstiles, rental car trackers, navigational devices, inventory monitors, etc.); and so forth.

In some embodiments, the network fabric 120 can support wired and wireless access as part of a single integrated infrastructure such that connectivity, mobility, and policy enforcement behavior are similar or the same for both wired and wireless endpoints. This can bring a unified experience for users, devices, and things that is independent of the access media.

In integrated wired and wireless deployments, control plane integration can be achieved with the WLC(s) 108 notifying the fabric control plane node(s) 110 of joins, roams, and disconnects by the wireless endpoints 130 such that the fabric control plane node(s) can have connectivity information about both wired and wireless endpoints in the network fabric 120, and can serve as the single source of truth for endpoints connected to the network fabric. For data plane integration, the WLC(s) 108 can instruct the fabric wireless access points 128 to form a VXLAN overlay tunnel to their adjacent fabric edge nodes 126. The AP VXLAN tunnel can carry segmentation and policy information to and from the fabric edge nodes 126, allowing connectivity and functionality identical or similar to that of a wired endpoint. When the wireless endpoints 130 join the network fabric 120 via the fabric wireless access points 128, the WLC(s) 108 can onboard the endpoints into the network fabric 120 and inform the fabric control plane node(s) 110 of the endpoints’ Media Access Control (MAC) addresses. The WLC(s) 108 can then instruct the fabric wireless access points 128 to form VXLAN overlay tunnels to the adjacent fabric edge nodes 126. Next, the wireless endpoints 130 can obtain IP addresses for themselves via Dynamic Host Configuration Protocol (DHCP). Once that completes, the fabric edge nodes 126 can register the IP addresses of the wireless endpoint 130 to the fabric control plane node(s) 110 to form a mapping between the endpoints’ MAC and IP addresses, and traffic to and from the wireless endpoints 130 can begin to flow.

FIG. 2 illustrates an example of a logical architecture for an enterprise network according to some aspects of the present disclosure. One of ordinary skill in the art will understand that, for logical architecture 200 and any system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure. In this example, the logical architecture 200 includes a management layer 202, a controller layer 220, a network layer 230 (such as embodied by the network fabric 120), a physical layer 240 (such as embodied by the various elements of FIG. 1), and a shared services layer 250.

The management layer 202 can abstract the complexities and dependencies of other layers and provide a user with tools and workflows to manage the network 100 (e.g., an enterprise network). The management layer 202 can include a user interface 204, design functions 206, policy functions 208, provisioning functions 210, assurance functions 212, platform functions 214, and base automation functions 216. The user interface 204 can provide a user a single point to manage and automate the network. The user interface 204 can be implemented within a web application/web server accessible by a web browser and/or an application/application server accessible by a desktop application, a mobile app, a shell program or other command line interface (CLI), an Application Programming Interface (e.g., restful state transfer (REST), Simple Object Access Protocol (SOAP), Service Oriented Architecture (SOA), etc.), and/or other suitable interface in which the user can configure network infrastructure, devices, and things that are cloud-managed; provide user preferences; specify policies, enter data; review statistics; configure interactions or operations, and so forth. The user interface 204 may also provide visibility information, such as views of a network, network infrastructure, computing devices, and things. For example, the user interface 204 can provide a view of the status or conditions of the network, the operations taking place, services, performance, a topology or layout, protocols implemented, running processes, errors, notifications, alerts, network structure, ongoing communications, data analysis, and so forth.

The design functions 206 can include tools and workflows for managing site profiles, maps and floor plans, network settings, and IP address management, among others. The policy functions 208 can include tools and workflows for defining and managing network policies. The provisioning functions 210 can include tools and workflows for deploying the network. The assurance functions 212 can use machine learning and analytics to provide end-to-end visibility of the network by learning from the network infrastructure, endpoints, and other contextual sources of information. The platform functions 214 can include tools and workflows for integrating the network management system with other technologies. The base automation functions 216 can include tools and workflows to support the policy functions 208, the provisioning functions 210, the assurance functions 212, and the platform functions 214.

In some embodiments, the design functions 206, the policy functions 208, the provisioning functions 210, the assurance functions 212, the platform functions 214, and the base automation functions 216 can be implemented as microservices in which respective software functions are implemented in multiple containers communicating with each rather than amalgamating all tools and workflows into a single software binary. Each of the design functions 206, policy functions 208, provisioning functions 210, assurance functions 212, and platform functions 214 can be viewed as a set of related automation microservices to cover the design, policy authoring, provisioning, assurance, and cross-platform integration phases of the network lifecycle. The base automation functions 216 can support the top-level functions by allowing users to perform certain network-wide tasks.

Returning to FIG. 2, the controller layer 220 can comprise subsystems for the controller layer 220 and may include a network control platform 222, a network data platform 224, and AAA services 226. These controller subsystems can form an abstraction layer to hide the complexities and dependencies of managing many network elements and protocols.

The network control platform 222 can provide automation and orchestration services for the network layer 230 and the physical layer 240, and can include the settings, protocols, and tables to automate management of the network and physical layers. For example, the network control platform 222 can provide the design functions 206, and the provisioning functions 210. The fully automated end-to-end migration process flow may be implemented using some of the functionalities provided by the network control platform 222. In addition, the network control platform 222 can include tools and workflows for discovering switches, routers, wireless controllers, and other network infrastructure devices (e.g., the network discovery tool); maintaining network and endpoint details, configurations, and software versions (e.g., the inventory management tool); Plug-and-Play (PnP) for automating deployment of network infrastructure (e.g., the network PnP tool), Path Trace for creating visual data paths to accelerate the troubleshooting of connectivity problems, Easy QoS for automating quality of service to prioritize applications across the network, and Enterprise Service Automation (ESA) for automating deployment of physical and virtual network services, among others. In some embodiments of the present technology, the automatic migration initiation process, that may be triggered by a user input, may leverage the Plug-and-Play (PnP) feature made available via network control platform 222. The network control platform 222 can communicate with network elements using Network Configuration (NETCONF)/Yet Another Next Generation (YANG), Simple Network Management Protocol (SNMP), Secure Shell (SSH)/Telnet, and so forth. In some embodiments, the Cisco® Network Control Platform (NCP) can operate as the network control platform 222

The network data platform 224 can provide for network data collection, analytics, and assurance, and may include the settings, protocols, and tables to monitor and analyze network infrastructure and endpoints connected to the network. The network data platform 224 can collect multiple types of information from network infrastructure devices, including Syslog, SNMP, NetFlow, Switched Port Analyzer (SPAN), and streaming telemetry, among others. The network data platform 224 can also collect use contextual information shared from

In some embodiments, one or more Cisco DNA® Center appliances can provide the functionalities of the management layer 202, the network control platform 222, and the network data platform 224. The Cisco DNA® Center appliances can support horizontal scalability by adding additional Cisco DNA® Center nodes to an existing cluster; high availability for both hardware components and software packages; backup and store mechanisms to support disaster discovery scenarios; role-based access control mechanisms for differentiated access to users, devices, and things based on roles and scope; and programmable interfaces to enable integration with third-party vendors. The Cisco DNA® Center appliances can also be cloud-tethered to provide for the upgrade of existing functions and additions of new packages and applications without having to manually download and install them.

The AAA services 226 can provide identity and policy services for the network layer 230 and physical layer 240, and may include the settings, protocols, and tables to support endpoint identification and policy enforcement services. The AAA services 226 can provide tools and workflows to manage virtual networks and security groups and to create group-based policies and contracts. The AAA services 226 can identify and profile network infrastructure devices and endpoints using AAA/RADIUS, 602.1X, MAC Authentication Bypass (MAB), web authentication, and EasyConnect, among others. The AAA services 226 can also collect and use contextual information from the network control platform 222, the network data platform 224, and the shared services 250, among others. In some embodiments, Cisco® ISE can provide the AAA services 226.

The network layer 230 can be conceptualized as a composition of two layers, an underlay 234 comprising physical and virtual network infrastructure (e.g., routers, switches, WLCs, etc.) and a Layer 3 routing protocol for forwarding traffic, and an overlay 232 comprising a virtual topology for logically connecting wired and wireless users, devices, and things and applying services and policies to these entities. Network elements of the underlay 234 can establish connectivity between each other, such as via Internet Protocol (IP). The underlay may use any topology and routing protocol.

In some embodiments, the network controller appliance(s) 104 can provide a local area network (LAN) automation service, such as implemented by Cisco DNA® Center LAN Automation, to automatically discover, provision, and deploy network devices. Once discovered, the automated underlay provisioning service can leverage Plug and Play (PnP) to apply the required protocol and network address configurations to the physical network infrastructure. In some embodiments, the LAN automation service may implement the Intermediate System to Intermediate System (IS-IS) protocol. Some of the advantages of IS-IS include neighbor establishment without IP protocol dependencies, peering capability using loopback addresses, and agnostic treatment of IPv4, IPv6, and non-IP traffic.

The overlay 232 can be a logical, virtualized topology built on top of the physical underlay 234, and can include a fabric data plane, a fabric control plane, and a fabric policy plane. In some embodiments, the fabric data plane can be created via packet encapsulation using Virtual Extensible LAN (VXLAN) with Group Policy Option (GPO). Some of the advantages of VXLAN-GPO include its support for both Layer 2 and Layer 3 virtual topologies (overlays), and its ability to operate over any IP network with built-in network segmentation.

In some embodiments, the fabric control plane can implement Locator/ID Separation Protocol (LISP) for logically mapping and resolving users, devices, and things. LISP can simplify routing by removing the need for each router to process every possible IP destination address and route. LISP can achieve this by moving remote destination to a centralized map database that allows each router to manage only its local routs and query the map system to locate destination endpoints.

The fabric policy plane is where intent can be translated into network policy. That is, the policy plane is where the network operator can instantiate logical network policy based on services offered by the network fabric 120, such as security segmentation services, quality of service (QoS), capture/copy services, application visibility services, and so forth.

Segmentation is a method or technology used to separate specific groups of users or devices from other groups for the purpose of reducing congestion, improving security, containing network problems, controlling access, and so forth. As discussed, the fabric data plane can implement VXLAN encapsulation to provide network segmentation by using the virtual network identifier (VNI) and Scalable Group Tag (SGT) fields in packet headers. The network fabric 120 can support both macro-segmentation and micro-segmentation. Macro-segmentation logically separates a network topology into smaller virtual networks by using a unique network identifier and separate forwarding tables. This can be instantiated as a virtual routing and forwarding (VRF) instance and referred to as a virtual network (VN). That is, a VN is a logical network instance within the network fabric 120 defined by a Layer 3 routing domain and can provide both Layer 2 and Layer 3 services (using the VXLAN VNI to provide both Layer 2 and Layer 3 segmentation). Micro-segmentation logically separates user or device groups within a VN, by enforcing source to destination access control permissions, such as by using access control lists (ACLs). A scalable group is a logical object identifier assigned to a group of users, devices, or things in the network fabric 120. It can be used as source and destination classifiers in Scalable Group ACLs (SGACLs). The SGT can be used to provide address-agnostic group-based policies.

In some embodiments, the fabric control plane node 110 may implement the Locator/Identifier Separation Protocol (LISP) to communicate with one another and with the network management system 102 (e.g., management cloud 102). Thus, the control plane nodes may operate a host tracking database, a map server, and a map resolver. The host tracking database can track the endpoints 130 connected to the network fabric 120 and associate the endpoints to the fabric edge nodes 126, thereby decoupling an endpoint’s identifier (e.g., IP or MAC address) from its location (e.g., closest router) in the network.

The physical layer 240 can comprise network infrastructure devices, such as switches and routers 110, 122, 124, and 126 and wireless elements 108 and 128 and network appliances, such as the network controller appliance(s) 104, and the AAA appliance(s) 106.

The shared services layer 250 can provide an interface to external network services, such as cloud services 252; Domain Name System (DNS), DHCP, IP Address Management (IPAM), and other network address management services 254; firewall services 256; Network as a Sensor (Naas)/Encrypted Threat Analytics (ETA) services; and Virtual Network Functions (VNFs) 260, among others. The management layer 202 and/or the controller layer 220 can share identity, policy, forwarding information, and so forth via the shared services layer 250 using APIs.

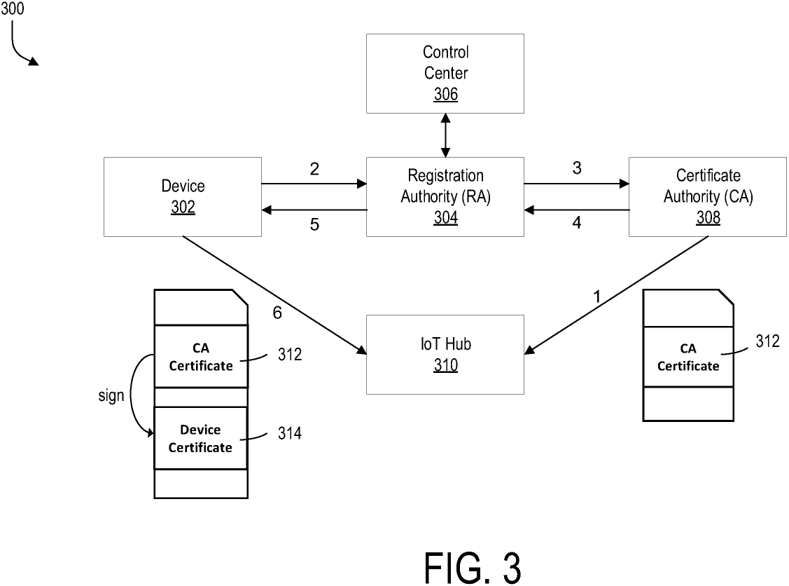

FIG. 3 illustrates a simplified network architecture of an enterprise network that utilizes a ZTD service, according to some aspects of the present disclosure. The enterprise network references in FIG. 3 may be the same as and include components and functionalities described above with reference to FIGS. 1 and 2. Architecture 300 may comprise of a device 302, registration authority (RA) 304, control center 306 (e.g., which can be the same as one or more control appliances 104), certificate authority (CA) 308, and IoT hub 310. While FIG. 3 illustrates a single device 302, architecture 300 may include tens or hundreds or even thousands of devices including IoT devices. Device 302 can be the same as any of endpoints 130 described with reference to FIG. 1.

Generally, RA 304 may be the same as or part of a cloud-based ZTD service. Hence, RA 304 may also be referred to as ZTD 304. In one example, RA 304 is a function for certificate enrollment used in PKIs. Upon receiving a certificate request from device 302 for initial enrollment or renewals, RA 304 can verify/authenticate device 302 with control center 440 and forward a CA certificate issued by CA 308. Device 302 can connect to IoT hub 310 with a device certificate, which is signed by the CA certificate.

As shown in FIG. 3, CA 308 can register CA certificates 312 with IoT hub 310 (step 1 on FIG. 3), which can be later used to verify device 302 requesting to connect to IoT hub 310 with a device certificate signed by CA 308 (or CA certificate issued by CA 308). When device 302 sends a certificate signing request to RA 304 (step 2 in FIG. 3), RA 304 first communicates with control center 306 to verify/authenticate device 302. Once RA 304 performs the authentication of device 302 based on the network information received from control center 306, RA 304 sends a certificate request to CA 308 (step 3 in FIG. 3). CA 308 issues a CA certificate and forwards it to RA 304 (step 4 in FIG. 3). RA 304 then forwards the certificate to device 302 (step 5 of FIG. 3) where the CA certificate signs a device certificate. As follows, device 302 can connect to IoT hub 310 using the device certificate 314 (step 6 of FIG. 3), which is signed by the CA certificate 312.

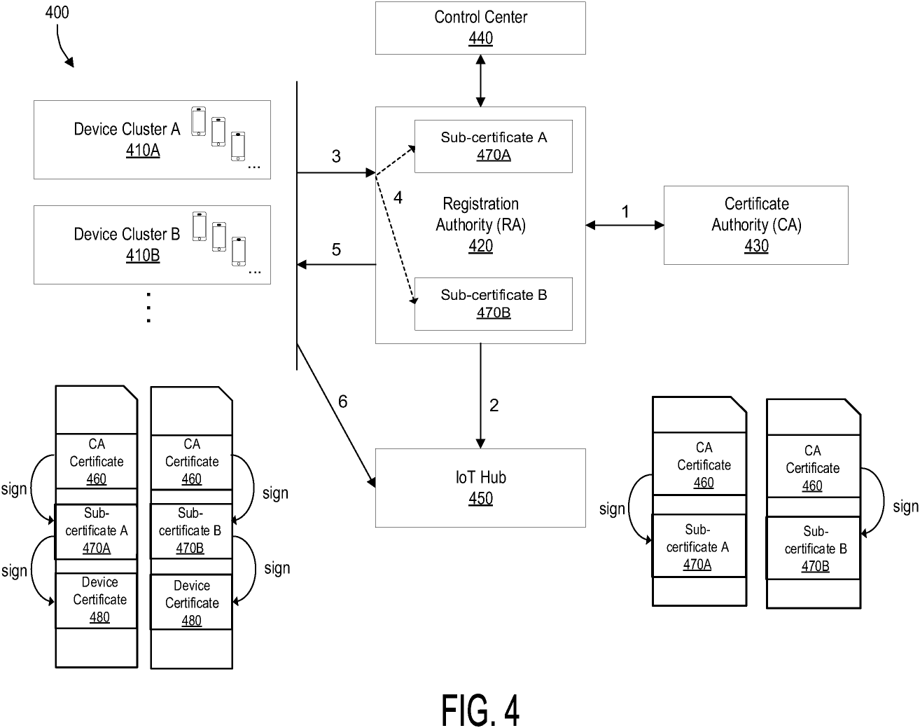

FIG. 4 illustrates an enhanced version of network architecture of FIG. 3, according to some aspects of the present disclosure. Network architecture 400 can comprise of device clusters 410A and 410B, RA 420, CA 430, control center 440 (can be the same as control center 306), and IoT hub 450 (can be the same as IoT hub 310).

According to some examples, a plurality of devices can be grouped into subsets of multiple devices such as device cluster A 410A and device cluster B 410B. Each of device cluster A 410A and device cluster B 410B can include one or more devices such as device 302. More specifically, one or more devices can be grouped into a device cluster based on policy, which is created by an enterprise operator (e.g., via control center 440). In some examples, the policy can include a required configuration of devices for a device cluster. For example, the policy can define that devices with the same Integrated Circuit Card Identifier (ICCID) are grouped together within one device cluster. In another example, the policy can define a threshold number of devices per device cluster (e.g., 10 devices per device cluster). In another example, the policy can define the grouping of devices to be based on a round-robin or a weighted round-robin method.

In some implementations, CA 430 can issue CA certificate 460 (i.e., root certificates). Further, CA 430 can create an intermediate CA, which then issues intermediate certificates (e.g., sub-certificate A 470A or sub-certificate B 470B). The creation of intermediate CA or issuance of intermediate certificates can be based on enterprise policy defined by a network operator via control center 440. While RA 420 manages sub-CAs, sub-CAs can reside within RA 420, CA 430, or by themselves in network architecture 400.

More specifically, CA 430 can issue CA certificates 460 (i.e., root certificates), which then signs sub-certificates 470A and 470B with its private key that makes the sub-certificates trusted. As follows, sub-certificates 470A and 470B can sign device certificates 480. Instead of creating device certificates directly under a root certificate authority, device certificates 480 can be signed by sub-certificates 470A and 470B from the intermediate CA.

According to some examples, RA 420 can obtain sub-certificates 470A and 470B issued by CA 430 (step 1 in FIG. 4). Further, RA 420 can register sub-certificates 470A and 470B with IoT hub 450 (step 2 in FIG. 4), which then can be used later to verify a device that may request to connect to IoT hub 450 with a device certificate, which is signed by the sub-certificates.

In some instances, a device, which is part of device clusters 410A or 410B can send a certificate signing request to RA 420 (step 3 in FIG. 4). Upon receipt of the request from the device, RA 420 can verify/authenticate the device based on the network information received from control center 440 (step 4 in FIG. 4). Once the authentication of the device is complete, RA 420 can forward sub-certificate 470A or 470B to a corresponding one of cluster A 410A and/or cluster B 410B (step 5 in FIG. 4). As follows, sub-certificate 470A or 470B can sign device certificate 480 for the device to connect to IoT hub 450 wherein IoT hub 450 can validate the signed device certificate 480 using sub-certificates A 470A or sub-certificates B 470B received from RA 420 at step 2 (step 6 in FIG. 4).

In some examples, a sub-CA (i.e., intermediate CA) can be created on-demand based on the enterprise policy in response to receiving a certificate signing request from a device.

In some implementation, for each policy, a new sub-CA can be created. The logical CAs can get first registered with a root CA (e.g., CA certificate 460 that is issued by CA 430) as an intermediary. Devices can get their device certificates that are issued by these dynamic sub-CAs.

In some examples, if an enterprise (not shown in FIG. 4) needs to revoke a large number of device certificates, the enterprise can identify the intermediate certificate that is linked to the device certificates (i.e., the intermediate certificate that signed the device certificates), and remove it from IoT hub 450. Under this approach, only a smaller subset of devices needs to be re-issued with new certificates. Also, the revocation and reissue can be done without disrupting the operations of other device clusters.

According to some examples, the proposed solution can be further extended to create and register a policy-linked sub-CA and then issue a linked intermediate certificate. Under this approach, a chain of logical sub-CAs can be created and managed behind the scenes inside the ZTD service (e.g., RA 420 as illustrated in FIG. 4), for example, CA certificate 460 that signs sub-certificate 470A and/or 470B, which then signs device certificates 480.

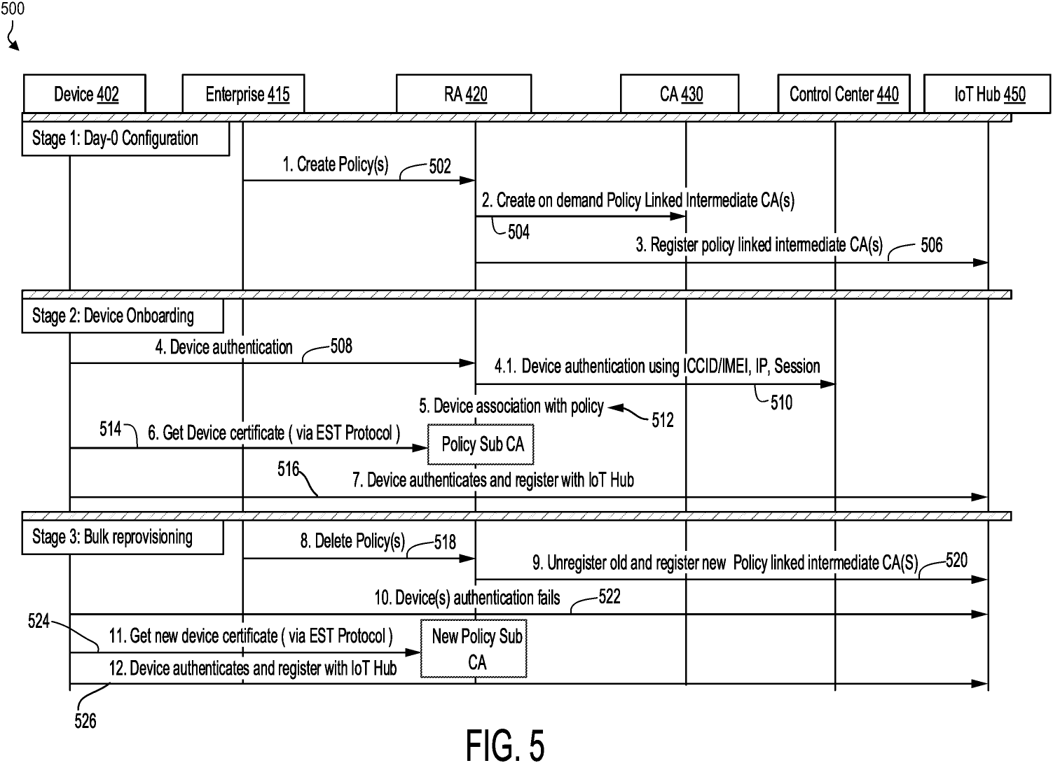

FIG. 5 illustrates a process flow for device certificate management in a ZTD environment, according to some aspects of the present disclosure. The example process flow 500 of FIG. 5 may be implemented within architecture 400. According to some examples, process flow 500 comprises three stages: Stage 1: day-0 configuration; Stage 2: device onboarding; and Stage 3: bulk reprovisioning.

In Stage 1 may be referred to as day-0 configuration stage where policy-based intermediate certificates are created prior to receiving registration requests from network devices such as IoT devices. Initially, at step 503, enterprise 415 creates policy(s) and sends the same to RA 420. Enterprise 415 may refer to an administrative portal through which an enterprise network operator can access and manage the entire enterprise network operation, define and manage network policies, security policies, etc. This portal can provide the network operator access to control center 440. The policy(s) related information can include parameters for forming groups of IoT devices, each of which may be associated with a different intermediate CA to be used for signing device certificates of IoT devices in that group. Examples of such parameters will be described further below.

At step 504, RA 420 may create policy-based intermediate certificates. For example, RA 420 may receive from CA 430 a number of intermediate certificates each of which is trusted/signed using a root certificate issued by CA 430. In some examples, RA 420 may determine a number of intermediate certificates it needs and sends a request to that number of intermediate certificates to CA 430. Such number may be based on any number of factors including policy-based parameters received at step 502 (e.g., a maximum number of policy-based intermediate certificates defined via enterprise 415, a number of IoT devices in the network and a threshold number of IoT devices in each sub-group to be associated with a different one of policy-based intermediate certificates, etc.). Once the intermediate certificates generated by CA 430 are received at RA 420, RA 420 creates policy-based (policy-linked) intermediate certificates such that each sub-certificate is associated with a different group (subset of IoT devices). For example, an enterprise may have 2000 vending machines (an example of an IoT device) with 1000 vending machines in New York and 1000 vending machines in Los Angeles. Through enterprise 415, an operator may specify a policy whereby each sub-certificate is to be used for signing device certificates of at most 1000 IoT devices and that vending machines in New York should be signed using a different intermediate certificate than the vending machines in Los Angeles. Accordingly, at step 504, RA 420 receives (or otherwise requests) two intermediate certificates from CA 430 and creates two policy-based intermediate certificates with one of the two intermediate certificates being used for signing device certificates of 1000 vending machines in New York and the other of the two intermediate certificates being used for singing device certificates of 1000 vending machines in Los Angeles.

At step 506, RA 420 can register policy-linked intermediate certificate(s) with IoT hub 450.

Stage 2 may be referred to as the on-boarding stage where a device (e.g., an IoT device) attempts to authenticate and register with the enterprise network using ZTD and RA 420. In doing so, at step 508, device 402 (which may a device within one of device cluster A 410A and device cluster B 410B as described above such as one of the vending machines described above) may send a registration request to RA 420 for connecting to the enterprise network. At step 510, RA 420 can authenticate device 402 using any known or to be developed technique. For example, RA 420 may send device identifying information such as Integrated Circuit Card Identifier (ICCID), International Mobile Equipment Identity (IMEI), Internet Protocol (IP), and/or Session Identifier to control center 440 for authenticating device 402 as a device that is authorized to connect to the network.

At step 512, RA 420 can associate device 402 with an enterprise-defined policy (e.g., policies created via enterprise 415 at step 502). For example, RA 420 using ICCID, IMEI, and/or IP address included in the registration request, may determine that device 402 form which a registration request is received at step 508 is a vending machine connected to the network in New York. Accordingly, at step 512, RA 420 associates device 402 with a policy-based intermediate certificate created at step 504 for signing device certificate of vending machines in New York.

At step 514, device 402 can obtain a device certificate (e.g., via Enrollment over Secure Transport (EST) protocol) signed by the corresponding policy-based intermediate certificate, which is signed by an intermediate certificate. After RA 420 signs the device certificate with the corresponding policy-based intermediate certificate and sends the same back to device 402, at step 516, device 402 can be authenticated and registered with IoT hub 450. In one example, device 402 may include its signed device certificate in its request to be registered with IoT hub 450. IoT hub 450 can verify device 402 because IoT hub 450 has the policy-based intermediate certificate stored therein (as was received by IoT hub 450 at step 506).

Stage 3 may be referred to as the reprovisioning stage where some of the policy-based intermediate certificates may be revoked due to any number of reasons including, but not limited to, device software updates, security breach of devices and/or the enterprise network, etc. As have been described and will be further emphasized below, one of the advantageous aspects of utilizing different policy-based intermediate certificates in signing device certificates for different subsets of devices, is that when an existing intermediate certificate need to be revoke for any reason, the reprovisioning will only affect a relevant subset of the devices and eliminate the need for revoking device certificates of an entire network of devices and reprovisioning them with new intermediate certificates.

To this extent, at step 518, and via enterprise 415, a network operator may delete and/or otherwise modify one or more policies that can potentially impact the device certificate signed for one or more connected IoT devices such as device 402.

At step 520, RA 420 unregisters old policy-linked intermediate certificates and registers new policy-linked intermediate certificates with IoT hub 450. As follows, device 402, which was issued the old policy-based intermediate certificate fails to authenticate with IoT hub 450 at step 522. Device 402 can restart the certificate process with RA 420 similar to steps 508-516 of Stage 2. At step 524, device 402 can get a new device certificate (e.g., via EST protocol). At step 526, device 402 can be authenticated and register with IoT hub 450 with the new device certificate.

As noted, device 402 may be associated with device cluster A 410A or device cluster B 410B. Therefore, revocation and renewal of the device certificate for device 402 may equally apply to other devices within the same cluster as device 402 without affecting the existing device certificates for devices in the other cluster. This way only a smaller subset of devices are issued new certificates, without disrupting the operations of devices in other clusters.

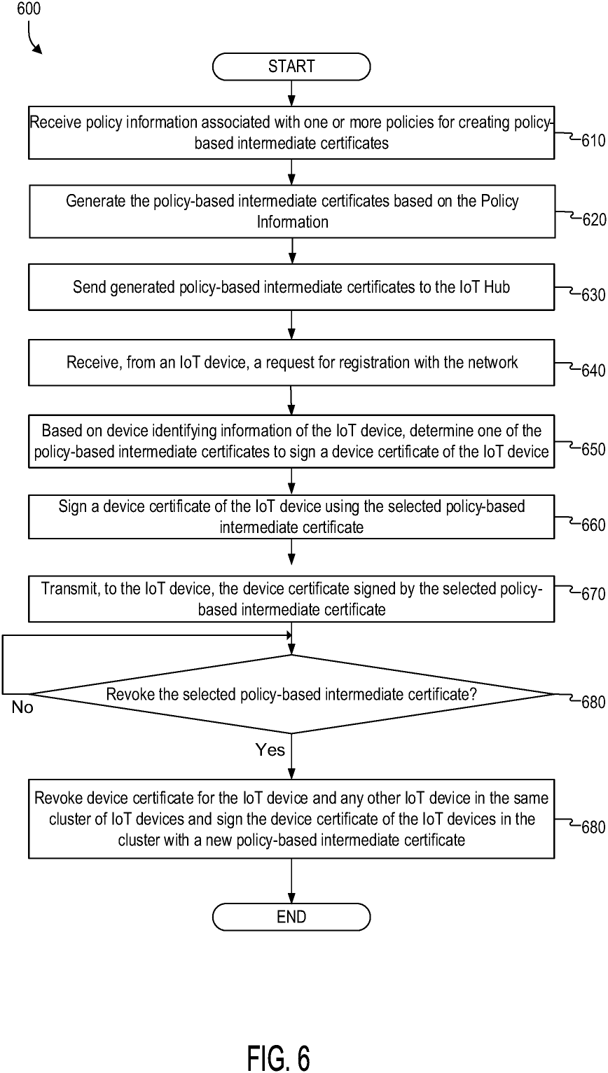

FIG. 6 illustrates an example method for device certificate management in a ZTD environment, according to some aspects of the present disclosure. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence. FIG. 6 will be described from the perspective of RA 420. It is noted that RA 420 may be a network component (e.g., cloud-based network component) with one or more memories having computer-readable instructions stored thereon and one or more processors configured to execute the compute-readable instructions to perform the steps of FIG. 6. RA 420 may also be referred to as a ZTD controller or simply a network controller.

At step 610, RA 420 may receive, from enterprise 415 (an enterprise network controller), policy information for creating intermediate certificates, which may be referred to as policy-based intermediate certificates. For example, RA 420 can receive policy information associated with policies for creating intermediate certificates from enterprise 415 as illustrated in FIG. 4.

In some examples, the policy information can include parameters for creating clusters (subsets or groups) of IoT devices with each cluster being ultimately associated with one policy-based intermediate certificate that can be used to sign device certificates of devices in that cluster. Such parameters can include, but are not limited to, a threshold number of devices per intermediate certificate. In some examples and as will be further described below, policy-based intermediate certificates may be created dynamically in cases where a previous (existing) policy-based intermediate certificate reaches a maximum (threshold) number of devices that it can be used to sign their device certificates. For example, the network policy can define a parameter that policy-based intermediate certificate A can be used to sign 100 device certificates. As such, when a registration request is received at RA 420 from a 101^{st} device, RA 420 can dynamically create a new policy-based intermediate certificate B to use for signing device certificate of the 101^{st} device since policy-based intermediate certificate A has reached the threshold according to the network policy.

Another example parameter can be a threshold number of policy-based intermediate certificates to be created. More specifically, a policy can include a pool of policy-based intermediate certificates, and one can be chosen dynamically based on an algorithm. For example, the parameter can define that 10 policy-based intermediate certificates are to be created. As follows, each one of the first 10 devices receives intermediate certificates 1 through 10, respectively. Each one of the second 10 devices also receives intermediate certificates 1 through 10, respectively. The order between policy-based intermediate certificate can be random, in a numeric order, or in any applicable way defined by the policy.

Another example parameter can be a configuration or type of devices according to which devices may be clustered and then associated with a particular policy-based intermediate certificate. For example, motion sensors’ device certificates (as examples of one type of IoT devices) may be signed with a first intermediate certificate while scanners’ device certificates (as examples of another type of IoT devices) may be signed with a second intermediate certificate. In another example, IoT devices with a particular software or configuration (e.g., 2.4 GHz Wi-Fi routers) may be clustered into one group while IoT devices with a different software or configuration (e.g., dual band 2.4 GHz and 5 GHz Wi-Fi routers) may be clustered into another group.

Another example parameter can be a combination of rules, for example, a threshold number of devices per intermediate certificate and/or a location of devices. For example, the enterprise policy can have a first intermediate certificate to be assigned to a maximum of 1000 devices in a first geographical region (e.g., 1000 vending machines in New York) and a second intermediate certificate to be assigned to a maximum of 1000 devices in a second geographical location (e.g., 1000 vending machines in Los Angeles).

At step 620, RA 420 may generate the policy-based intermediate certificates based on the policy information, the policy information including parameters for organizing the connected IoT devices into a plurality of clusters, as described above. In one example, to generate the policy-based intermediate certificates, RA 420 may request one or more intermediate certificates from CA 430. As noted above, each intermediate certificate may be generated by CA 430 and signed with a root certificate also generated by CA 430. Once the requested intermediate certificates are received from CA 430 (e.g., sub-certificates 470A or 470B as illustrated in FIG. 4), then RA 420 may associate each one with a different cluster of IoT devices formed according to the policy information, thus generating policy-based intermediate certificates.

At step 630, RA 420 may send the policy-based intermediate certificates to IoT hub 450 to be stored for validating IoT devices that may later attempt to connect to IoT Hub 450. In other words, IoT hub 450 may use the policy-based intermediate certificates stored thereon to validate the signed device certificate of any IoT device attempting to register with and connect to IoT hub 450.

At step 640, RA 420 may receive, from a device (e.g., an IoT device 302), a registration request for a certificate (i.e., a certificate signing request). This process can be performed as described above with reference to steps 508 and 510 of FIG. 5. As part of the registration request, RA 420 may also receive device identifying information (e.g., ICCID, IMEI, IP address, session information, device type and configuration, etc.).

At step 650, RA 420 may determine (select) a policy-based intermediate certificate to sign the device certificate of the IoT device from which the registration request is received at step 640. This determination of which policy-based intermediate certificate to use is based at least in part on the identifying information of the device. For example, RA 420 may determine that the IoT device from which the registration request is received at step 640 is a vending machine in New York. Accordingly, RA 420 may utilize a policy-based intermediate certificate that it has been using to sign device certificates of vending machines in New York to sign the device certificate of this vending machine in New York as well. In other words, one example process of determining the appropriate policy-based intermediate certificate includes associating the device with one of the clusters of devices formed based on the parameters and using the policy-based intermediate certificate for that cluster to which the device belongs, to sign the device certificate of the device (e.g., the vending machine).

As noted above, generation of policy-based intermediate certificates and the determination of which policy-based intermediate certificate to use may be dynamic. In other words, the generation of a new policy-based intermediate may not necessarily happen prior to receiving a registration request from an IoT device but instead may occur at step 650 (steps 620 and 630 may occur at step 650). In one instance, an example policy information may indicate that an intermediate certificate may be utilized to sign a device certificate of a maximum of 1000 vending machines in New York. However, at step 640, the registration request received may be from a 1001^{st} vending machine in New York. Because RA 420 can no longer use the same policy-based intermediate certificate that it has used previously to sign the device certificate of 1000 vending machines in New York, RA 420 may determine, on-demand, that a new policy-based intermediate certificate is needed and thus may request a new intermediate certificate from CA 430, generate the new policy-based intermediate certificate, send the new policy-based intermediate certificate to IoT hub 450, and use the same to sign the device certificate of the 1001^{st} vending machine in New York, from which the registration request is received at step 420.

In another example, dynamic determination of which policy-based intermediate certificate to use for signing device certificates may such that RA 420 chooses an applicable policy-based intermediate certificate, from a pool of applicable policy-based intermediate certificates, to sign the device certificate of the IoT device such that the number of IoT devices associated with each applicable policy-based intermediate certificate is optimized. This optimization may be a configurable criterion determined based on experiments and/or empirical studies.

At step 660, RA 420 may sign a device certificate of the IoT device from which the registration request is received at step 640, by the policy-based intermediate certificate determined at step 650. Signing a device certificate using the policy-based intermediate certificate may be performed according any known or to be developed method of signing device certificates.

At step 670, RA 420 may transmit, to the device, the device certificate signed by the policy-based intermediate certificate at step 660. As described above, the device may then use the signed device certificate to connect to IoT hub 450. In establishing such connection, IoT hub 450 utilizes the stored policy-based intermediate certificates it received at step 630 from RA 420.

At step 680, RA 420 determines if a “currently in-use” policy-based intermediate certificate needs to be revoked (canceled). A currently in-use policy-based intermediate certificate may refer to an active certificate currently used for signing device certificates of one or more connected IoT devices. Such revocation can be based on any number of triggers. For example, the policy-based intermediate certificate may expire, there may be a system breach or a virus affecting a number of network devices including IoT devices, etc. If no such revocation is needed (NO at step 680), step 680 is repeated until such determination is made.

However, if RA 420 determines that one or more policy-based intermediate certificates are to be revoked (YES at step 680), then at step 690, RA 420 identifies the cluster or group of devices associated with such policy-based intermediate certificate(s) that need to be revoked, and revokes (invalidates) their respective device certificates signed by such policy-based intermediate certificate(s). Pursuant to such revocation, RA 420 can sign their respective device certificates with a new policy-based intermediate certificate in a similar manner as described above with reference to steps 610-670.

Examples of the IoT device certificate management techniques described above can provide the following advantages compared to currently utilized methods. By using policy-based intermediate certificates to sign device certificates of clusters of devices (different subsets of all devices), the need for mass invalidation of all device certificates (which currently needs to happen when all devices are signed using a root certificate, should the root certificate be revoked). This can be a horizontally scalable approach for certificate creation, management, and revocation that can significantly reduce the complexities associated with management of certificates to validate thousands, hundreds of thousands, and even millions of IoT devices, as their use across enterprise networks of all size of type become more prevalent.

The IoT device certificate management according to the present disclosure can further provide fast network connection and control in case of a security incident. As described above, if one and only certificate authority is compromised, all the devices that have the certificate signed by a compromised certificate authority are at risk and will need to be reissued new signed device certificates. Splitting the devices into subsets (clusters) of devices, with each subset being associated with a different policy-based intermediate certificate limits the scope of the need for revoking and renewing device certificates to only the subset(s).

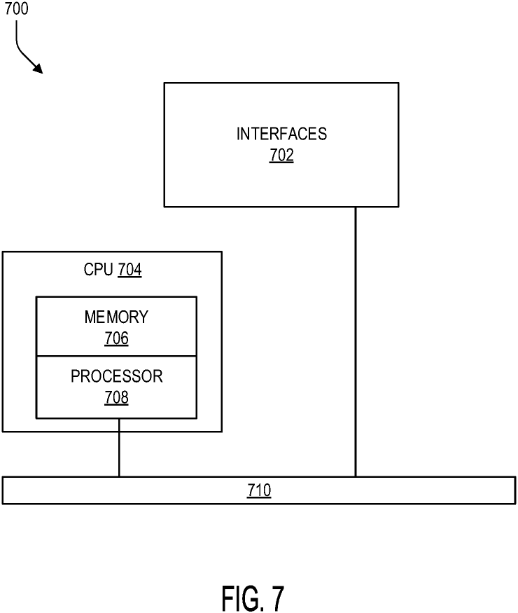

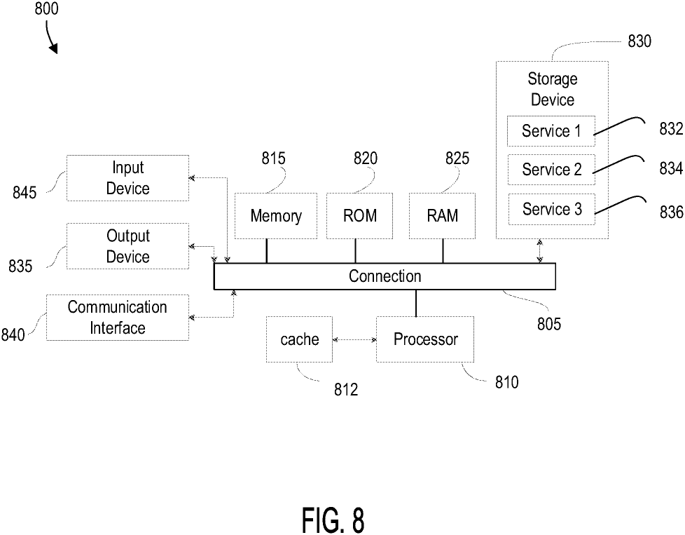

With various examples of enterprise networks, ZTD services implemented in such networks and the use of policy-based intermediate certificates as part of the ZTD services described above with reference to FIGS. 1-6, the disclosure now turns to FIGS. 7 and 8 that describe example network devices and computing devices, such as switches, routers, load balancers, client devices, and so forth. Such example network and computing devices may be used to implement various components described above with reference to FIGS. 1-7 including, but not limited to, RA 420 and CA 430.

FIG. 7 illustrates an example of a network device, according to some aspects of the present disclosure. FIG. 7 illustrates an example network device 700 suitable for performing switching, routing, load balancing, and other networking operations. Network device 700 includes a central processing unit (CPU) 704, interfaces 702, and a bus 710 (e.g., a PCI bus). When acting under the control of appropriate software or firmware, the CPU 704 is responsible for executing packet management, error detection, and/or routing functions. The CPU 704 preferably accomplishes all these functions under the control of software including an operating system and any appropriate applications software. CPU 704 may include one or more processors 708, such as a processor from the INTEL X86 family of microprocessors. In some cases, processor 708 can be specially designed hardware for controlling the operations of network device 700. In some cases, a memory 706 (e.g., non-volatile RAM, ROM, etc.) also forms part of CPU 704. However, there are many different ways in which memory could be coupled to the system.

The interfaces 702 are typically provided as modular interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master CPU 704 to efficiently perform routing computations, network diagnostics, security functions, etc.

Although the system shown in FIG. 7 is one specific network device of the present technology, it is by no means the only network device architecture on which the present technology can be implemented. For example, an architecture having a single processor that handles communications as well as routing computations, etc., is often used. Further, other types of interfaces and media could also be used with the network device 700.

Regardless of the network device’s configuration, it may employ one or more memories or memory modules (including memory 706) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 706 could also hold various software containers and virtualized execution environments and data.

The network device 700 can also include an application-specific integrated circuit (ASIC), which can be configured to perform routing and/or switching operations. The ASIC can communicate with other components in the network device 700 via the bus 710, to exchange data and signals and coordinate various types of operations by the network device 700, such as routing, switching, and/or data storage operations, for example.

FIG. 8 illustrates an example computing system, according to some aspects of the present disclosure. FIG. 8 illustrates an example computing system 800 including components in electrical communication with each other using a connection 805 upon which one or more aspects of the present disclosure can be implemented. Connection 805 can be a physical connection via a bus, or a direct connection into processor 810, such as in a chipset architecture. Connection 805 can also be a virtual connection, networked connection, or logical connection.

In some embodiments computing system 800 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read only memory (ROM) 820 and random access memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A method comprising:
receiving network policy information to be used for creating policy-based intermediate certificates, each one of the policy-based intermediate certificates being used by a network controller for signing devices certificates of a different cluster of connected IoT devices;
receiving, from an IoT device, a request for registration with the network controller;
based on identifying information of the IoT device included in the request, determining one of the policy-based intermediate certificates to sign a device certificate of the IoT device; and
transmitting, to the IoT device, the device certificate signed using the one of the policy-based intermediate certificates.

2. The method of claim 1, further comprising:
generating, by the network controller, the policy-based intermediate certificates based on the policy information, the policy information including parameters for organizing the connected IoT devices into a plurality of clusters.

3. The method of claim 2, wherein the parameters include one or more of a device type, device configurations, a geographical location of an IoT device, and a threshold number of IoT devices to be associated with each of the plurality of clusters.

4. The method of claim 3, wherein determining one of the policy-based intermediate certificates for signing the device certificate of the IoT device comprises associating the IoT device with one of the plurality of clusters based on the identifying information of the IoT device, the one of the plurality of clusters being associated with one of the policy-based intermediate certificates.

5. The method of claim 1, wherein each policy-based intermediate certificate is linked to a root certificate issued by a certificate authority.

6. The method of claim 1, further comprising:
determining that one or more of the policy-based intermediate certificates are to be revoked;
identifying a group of IoT devices associated with each of the one or more of the policy-based intermediate certificates that are to be revoked;
revoking signed device certificates for the group of IoT devices; and
signing the device certificates for the group of IoT devices using a new policy-based intermediate certificate.

7. The method of claim 1, further comprising:
dynamically generating the policy-based intermediate certificates when registration requests from one or more IoT devices are received at the network controller.

8. A network controller, comprising:
one or more memories having computer-readable instructions stored therein; and
one or more processors configured to execute the computer-readable instructions to:
receive network policy information to be used for creating policy-based intermediate certificates, each one of the policy-based intermediate certificates being used by the network controller for signing devices certificates of a different cluster of connected IoT devices;
receive, from an IoT device, a request for registration with the network controller;
based on identifying information of the IoT device included in the request, determine one of the policy-based intermediate certificates to sign a device certificate of the IoT device; and
transmit, to the IoT device, the device certificate signed using the one of the policy-based intermediate certificates.

9. The network controller of claim 8, wherein the one or more processors are further configured to execute the computer-readable instructions to generate the policy-based intermediate certificates based on the policy information, the policy information including parameters for organizing the connected IoT devices into a plurality of clusters.

10. The network controller of claim 9, wherein the parameters include one or more of a device type, device configurations, a geographical location of an IoT device, and a threshold number of IoT devices to be associated with each of the plurality of clusters.

11. The network controller of claim 10, wherein the one or more processors are further configured to execute the computer-readable instructions to determine one of the policy-based intermediate certificates for signing the device certificate of the IoT device by associating the IoT device with one of the plurality of clusters based on the identifying information of the IoT device, the one of the plurality of clusters being associated with one of the policy-based intermediate certificates.

12. The network controller of claim 8, wherein the one or more processors are further configured to execute the computer-readable instructions to:
determine that one or more of the policy-based intermediate certificates are to be revoked;
identify a group of IoT devices associated with each of the one or more of the policy-based intermediate certificates that are to be revoked;
revoke signed device certificates for the group of IoT devices; and
sign the device certificates for the group of IoT devices using a new policy-based intermediate certificate.

13. The network controller of claim 8, wherein the one or more processors are further configured to execute the computer-readable instructions to dynamically generate the policy-based intermediate certificates when registration requests from one or more IoT devices are received at the network controller.

14. The network controller of claim 8, wherein the network controller is a Zero Touch Deployment (ZTD) controller of a ZTD service used in an enterprise network to on-board and manage connected IoT devices.

15. One or more non-transitory computer-readable media comprising computer-readable instructions, which when executed by one or more processors of a network controller, cause the network controller to:
receive network policy information to be used for creating policy-based intermediate certificates, each one of the policy-based intermediate certificates being used by the network controller for signing devices certificates of a different cluster of connected IoT devices;
receive, from an IoT device, a request for registration with the network controller;
based on identifying information of the IoT device included in the request, determine one of the policy-based intermediate certificates to sign a device certificate of the IoT device; and
transmit, to the IoT device, the device certificate signed using the one of the policy-based intermediate certificates.

16. The one or more non-transitory computer-readable media of claim 15, wherein the execution of the computer-readable media by the one or more processors, further cause the network controller to generate the policy-based intermediate certificates based on the policy information, the policy information including parameters for organizing the connected IoT devices into a plurality of clusters.

17. The one or more non-transitory computer-readable media of claim 16, wherein the parameters include one or more of a device type, device configurations, a geographical location of an IoT device, and a threshold number of IoT devices to be associated with each of the plurality of clusters.

18. The one or more non-transitory computer-readable media of claim 17, wherein the execution of the computer-readable media by the one or more processors, further cause the network controller to determine one of the policy-based intermediate certificates for signing the device certificate of the IoT device by associating the IoT device with one of the plurality of clusters based on the identifying information of the IoT device, the one of the plurality of clusters being associated with one of the policy-based intermediate certificates.

19. The one or more non-transitory computer-readable media of claim 15, wherein the execution of the computer-readable media by the one or more processors, further cause the network controller to:
determine that one or more of the policy-based intermediate certificates are to be revoked;
identify a group of IoT devices associated with each of the one or more of the policy-based intermediate certificates that are to be revoked;
revoke signed device certificates for the group of IoT devices; and
sign the device certificates for the group of IoT devices using a new policy-based intermediate certificate.

20. The one or more non-transitory computer-readable media of claim 15, wherein the execution of the computer-readable media by the one or more processors, further cause the network controller to dynamically generate the policy-based intermediate certificates when registration requests from one or more IoT devices are received at the network controller.
